(19) United States
(12) Patent Application Publication
(10) Pub. No.: US 2016/0119438 A1
(43) Pub. Date: Apr. 28, 2016

(54) SYSTEMS AND METHODS OF SHARING MEDIA AND DATA CONTENT ACROSS DEVICES THROUGH LOCAL PROXIMITY

(71) Applicant: Google Inc., Mountain View, CA (US)

(72) Inventors: Andrew Abramson, Sunnyvale, CA (US); Benjamin David Poiesz, Santa Clara, CA (US)

(21) Appl. No.: 14/521,507

(22) Filed: Oct. 23, 2014

(51) Int. Cl. H04L 29/08; H04W 4/00; H04L 29/06

(52) U.S. Cl. CPC H04L 67/18; H04L 65/607; H04W 4/008

(57) ABSTRACT

Systems and methods of sharing media content between devices are disclosed that include determining a change in presence when an electronic device is within a predetermined proximity of a display device, transmitting a notification to the electronic device within the predetermined proximity, the notification requesting input from the electronic device to accept or decline sharing media content data with the display device, and transmitting the media content data to the display device when the acceptance input is received. The display device and/or the server may determine when the electronic device is within the predetermined proximity. When the sharing of media content is accepted, media content data can be provided from the electronic device and/or a server to the display device.

### BACKGROUND

Present television display devices that are communicatively connectable to other devices via a communication network to provide media content are referred to as smart TVs. The smart TVs typically have media account associations that are tied to a particular user. For example, a home may have a smart TV, and the media accounts associated with the smart TV are typically associated with one member of the household. There may be difficulties in having these present smart TVs play content associated with users that do not have accounts associated with the smart TV in a particular home. For example, a visitor to a home with a smart TV may experience difficulty in playing back media content on a smart TV that is not theirs, and thus does not have any of the visitor's account information. That is, because the visitor's account is not on the smart TV, the smart TV would not have access or knowledge of content owned or available to the visitor. Although the visitor could manually add their account information to the smart TV to access the desired content, such an operation is undesirable because of the length of time to provision the visitor's account on the smart TV, entering credentials on a smart TV that is owned and used by people other than the guest, as well as being inconvenient for the visitor, who would have to remove at least the account information when finished.

### BRIEF SUMMARY

Accordingly, embodiments of the disclosed subject matter provide systems and method of sharing media content with an electronic device, where content can be provided to a display device, such as a smart TV, by another who does not have account information stored on the display device. In particular, the embodiments of the disclosed subject matter enable the individual to seamlessly provide content, across all of the individual's sources, to the display device. The embodiments of the disclosed subject matter further provide dynamic installation of any applications or software to view the media content provided by the individual, as well as provisioning accounts to view the content.

According to an embodiment of the disclosed subject matter, a method is provided that includes determining a change in presence when an electronic device is within a predetermined proximity of a display device, transmitting a notification to the electronic device within the predetermined proximity, the notification requesting input from the electronic device to accept or decline sharing media content data with the display device, and transmitting the media content data to the display device when the acceptance input is received.

According to an embodiment of the disclosed subject matter, a system is provided that includes an electronic device to provide media content data, a display device, and a server to determine a change in presence when the electronic device is within a predetermined proximity of the display device according to data transmitted from the electronic device to the server, and to transmit media content to the display device according to the media content data provided by the electronic device when an input is received to share the media content data and when a selection of a media content item of the media content data is received.

According to an embodiment of the disclosed subject matter, a system is provided that includes an electronic device to provide media content data, a display device to determine a change in presence when the electronic device is within a predetermined proximity of the display device according to data communication between the display device and the electronic device, and a server to transmit media content to the display device according to the media content data provided by the electronic device when an input is received to share the media content data and when a selection of a media content item of the media content data is received.

According to an embodiment of the disclosed subject matter, means for sharing media content between devices is provided that include determining a change in presence when an electronic device is within a predetermined proximity of a display device, transmitting a notification to the electronic device within the predetermined proximity, the notification requesting input from the electronic device to accept or decline sharing media content data with the display device, and transmitting the media content data to the display device when the acceptance input is received.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computing device according to an embodiment of the disclosed subject matter.

FIG. 2 shows a network configuration according to an embodiment of the disclosed subject matter.

FIG. 3 shows an example network and system configuration according to an embodiment of the disclosed subject matter.

FIG. 4 shows an example method of sharing media content data between an electronic device and a display device according to an embodiment of the disclosed subject matter.

FIG. 5A shows an operation of the method illustrated in FIG. 4, the operation including identifying the electronic device with the display device according to an embodiment of the disclosed subject matter.

FIG. 5B shows an operation of the method illustrated in FIG. 4, the operation including identifying the electronic device with a server, which provides updated presence data to the display device according to an embodiment of the disclosed subject matter.

FIG. 6 shows an example display screen that is displayed on an electronic device to receive an input as to whether to share media content data with a display device according to an embodiment of the disclosed subject matter.

FIGS. 7A-7B show example display screens that are displayed on the display device to receive a selection of a shared media content item or a native media content item according to an embodiment of the disclosed subject matter.

### DETAILED DESCRIPTION

Embodiments of the presently disclosed subject matter include systems and methods of sharing content between an electronic device (e.g., a mobile computing device, such as a smart phone, tablet computer, laptop, or wearable computing device) and a display device (e.g., a smart TV). The shared content may be shared media content data, where the media content data can include at least one of video media content, audio media content, game media content, game data, application content, application data, image media content, subscription data, account data, media purchase data, authorization data, user profile data, electronic device data, and digital right management (DRM) keys to decrypt the selected media content data.

The systems and methods include determining a change in presence when the electronic device is within a predetermined proximity of the display device. A notification can be transmitted to the electronic device when it is within the predetermined proximity, where the notification requests input from the electronic device to accept or decline sharing media content data with the display device. The media content data can be transmitted to the display device when the acceptance input is received. In embodiments of the presently disclosed subject matter, the determining the change in presence can include exchanging data between the display device and the electronic device so that the display device can identify the electronic device when the electronic device is within the predetermined proximity to the display device. In other embodiments of the presently disclosed subject matter, the determining the change in presence can include exchanging data between the electronic device and a server, so as to provide at least location information of the electronic device to the server. The display device can receive updated presence data from the server for the electronic device according to the data exchanged between the display device and the server so that the display device can identify the electronic device as being within the predetermined proximity to the display device.

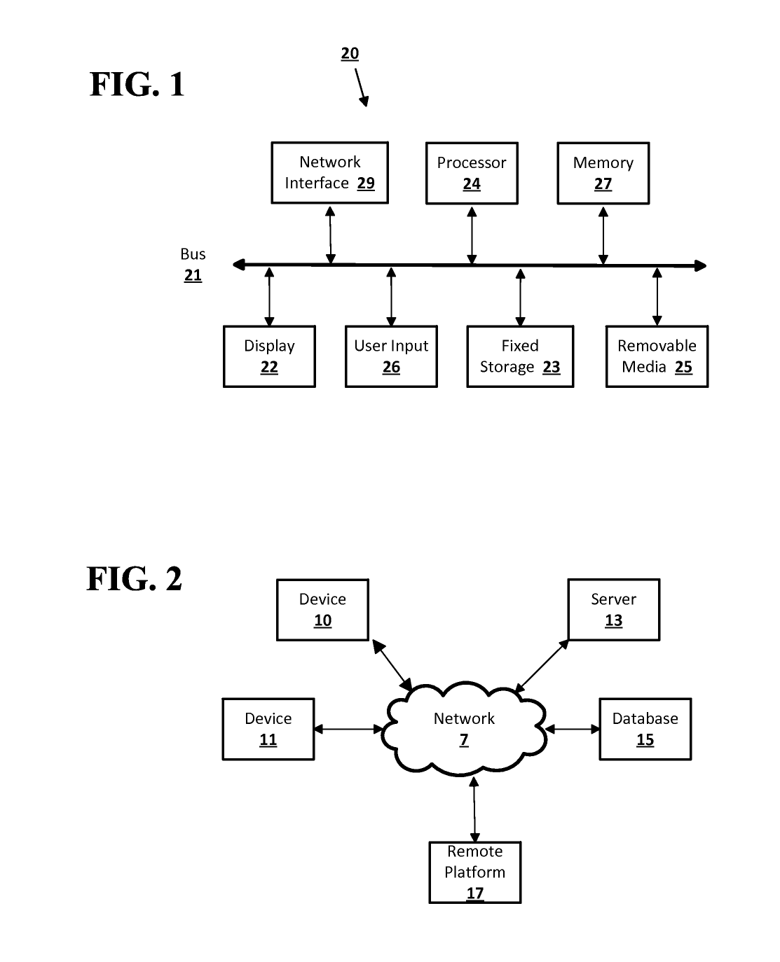

Embodiments of the presently disclosed subject matter may be implemented in and used with a variety of component and network architectures. FIG. 1 is an example computing device 20 suitable for implementing embodiments of the presently disclosed subject matter. The device 20 may be, for example, a desktop or laptop computer, or a mobile computing device such as a smart phone, tablet, wearable computing device, smart TV, or the like. That is, in the exemplary embodiments of the disclosed subject matter, the electronic device and the display device described throughout may be the computing device 20 illustrated in FIG. 1 and described below. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computing device 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., digital cameras, digital video recorders (DVRs), set-top boxes, home media servers, personal media players, gaming consoles, and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more devices 10, 11, such as display devices, smart TVs, local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The servers 13 and/or databases 15 may store media content that may be transmitted to the devices 10, 11 when, for example, permission by a user is granted, and/or when a selection of a media content item is received by the devices 10, 11. The remote devices may be directly accessible by the devices 10, 11, or one or more other devices may provide intermediary access such as where a server 13 provides access to resources stored in a database 15. The database 15 may include account information for a user related to media content items. The devices 10, 11 also may access remote platforms 17 or services provided by remote platforms 17 such as cloud computing arrangements and services. The remote platforms 17 may include media content distribution services that provide video content, audio content, game content, image content, and the like. The remote platform 17 may include one or more servers 13 and/or databases 15.

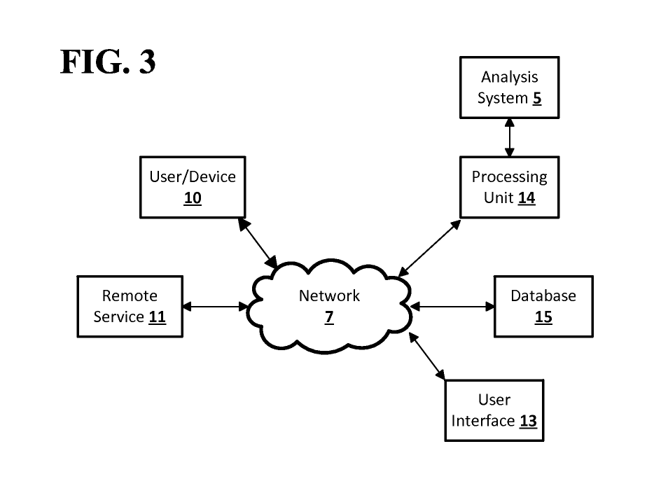

FIG. 3 shows an example arrangement according to an embodiment of the disclosed subject matter. One or more devices or systems 10, 11, such as remote services or service providers 11, user devices 10 such as display devices, smart TVs, local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11. In another example, the user interface 13 may provide different interfaces to different clients to manage the authorization of sharing media content, as well as the selection and presentation of media content items that are authorized to be shared from one user device to another, such as from a smart phone, tablet computer, or the like and a smart TV, display device, or the like.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. The content delivery system can include a video content delivery system, an audio content delivery system, a game content delivery system, an image content delivery system, and the like. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

In situations in which the systems, such as those illustrated in FIGS. 1-3 and discussed here, collect personal information about users, or may make use of personal information, the users may be provided with an opportunity to control whether programs or features collect user information (e.g., information about a user's social network, social actions or activities, a user's preferences, a user's current location, a user's account information), or to control whether and/or how to receive content from the content server to be provided to the electronic display. In addition, certain data may be treated in one or more ways before it is stored or used, so that personally identifiable information is removed. Thus, the user may have control over how information is collected about the user and used by a system as disclosed herein.

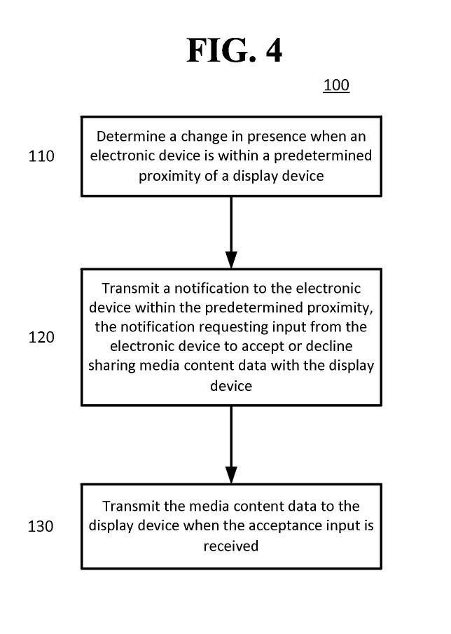

FIG. 4 shows an example method 100 of sharing media content data between an electronic device and a display device according to an embodiment of the disclosed subject matter. In operation 110, a change in presence may be determined when an electronic device is within a predetermined proximity of a display device. The predetermined proximity may be, for example, within one meter, five meters, ten meters, or any other suitable distance. In example embodiments of the presently disclosed subject matter, the display device can determine when an electronic device is within a predetermined proximity of the display device. In other example embodiments of the presently disclosed subject matter, a server can determine when the electronic device is within a predetermined proximity of the display device.

In exemplary embodiments of the disclosed subject matter, in operation 110, a change in presence may be determined when an electronic device is within a predetermined proximity of a display device, where the predetermined proximity is determined according to, for example, a short for service set identifier (SSID). SSIDs are generally a unique identifier attached to a header of packets sent over, for example, a wireless local-area network (WLAN) that acts as a password when a device (e.g., a mobile device) attempts to connect to a basic service set (BSS). The SSID differentiates one network from another, so that access points and devices attempting to connect to a specific network (e.g., a WLAN) must use the same SSID. The SSID allows devices to connect to a desired network when multiple independent networks operate in the same physical area. In operation 110, the electronic device and the display device can be determined to be within a predetermined proximity with one another if they are part of the same network (e.g., a WLAN) according to the SSID.

In example embodiments of the presently disclosed subject matter, the display device can determine when an electronic device is within a predetermined proximity of the display device when the SSID of the display device and the electronic device are the same. In other example embodiments of the presently disclosed subject matter, a server can determine when the electronic device is within a predetermined proximity of the display device, when the server determines that the SSID of the display device and the electronic device are the same.

In exemplary embodiments of the disclosed subject matter, in operation 110, a change in presence may be determined when an electronic device and the display device are determined to be in the same near-me area network (NAN). Generally, NAN is a logical communication network that is directed to communication among devices (e.g., wireless devices) in close proximity. Unlike local area networks (LANs), in which the devices are in the same network segment and share the same broadcast domain, the devices in a NAN can belong to different network infrastructures. For example, even though the electronic device and the display device are geographically close, the communication path between them might, in fact, traverse a long distance, going from a LAN, through the Internet, and to another LAN. That is, in NAN, there may be two-way communications among the electronic device and the display device that are within a certain proximity to each other, but the NAN is not generally concerned with the exact locations.

In example embodiments of the presently disclosed subject matter, the display device can determine when an electronic device is within a predetermined proximity of the display device according to whether the display device and the electronic device are part of the same NAN. In other example embodiments of the presently disclosed subject matter, a server can determine when the electronic device is within a predetermined proximity of the display device, when the server determines that the display device and the electronic device are in the same NAN.

In exemplary embodiments of the disclosed subject matter, in operation 110, a change in presence may be determined when an electronic device and the display device determine how close they are from one another in a peer-to-peer manner, by exchanging, for example, network characteristics observed in real time. For example, the proximity of the electronic device to the display can be determined in a network by detecting and/or receiving wireless signals with the display device, such as any network characteristics (e.g., network information) and/or communication link characteristics (e.g., communication link information) from the electronic device. The network characteristics may include, for example, signal strength, noise level, and MAC address. The network and/or communication link characteristics of the display device and the electronic device can be compared. When the network and/or communication characteristics are within a predetermined relationship (e.g., the signal strength is greater than or equal to a predetermined level, the MAC address is a pre-approved MAC address, etc.), the display device can determine that the electronic device is within a predetermined proximity.

In exemplary embodiments of the disclosed subject matter, in operation 110, a change in presence may be determined when an electronic device and the display device are determined to have a communication link signal strength between one another that is greater than or equal to a predetermined level.

In exemplary embodiments of the disclosed subject matter, in operation 110, a change in presence may be determined according to whether a state of proximity between the display device and the electronic device is expected to occur at a future time based at least in part on a current or past motion state of at least one of the devices (e.g., the electronic device), and/or a historic behavior of at least one of the devices (e.g., the electronic device), and/or an identification that the display device and the electronic device are in a common venue.

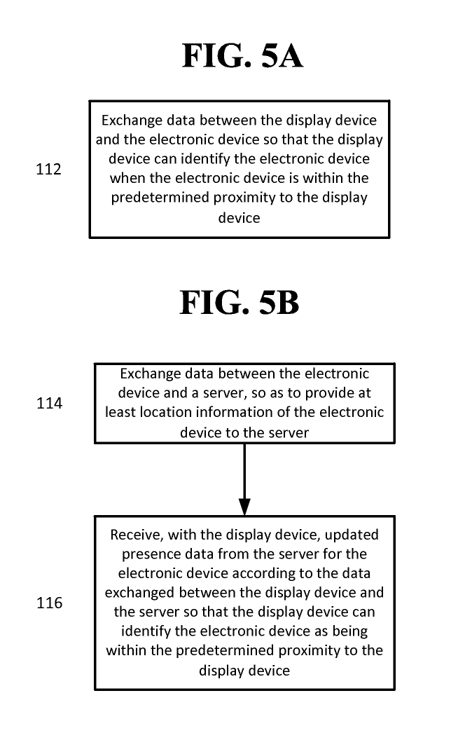

FIG. 5A relates to operation 110 of FIG. 4, which shows a change in presence may be determined when an electronic device is within a predetermined proximity of a display device. In operation 112 of FIG. 5A, an exchange of data can occur between the display device and the electronic device so that the display device can identify the electronic device when the electronic device is within the predetermined proximity to the display device. That is, the electronic device may, for example, periodically transmit request messages using a communication protocol within a predetermined range to determine whether an electronic device is within the presence of the display device. When the electronic device is within the predetermined range of the display device, a response message may be transmitted from the electronic device to the display device, where the response message includes information that at least identifies the electronic device. Accordingly, the display device can determine a change in presence (i.e., that the electronic device is within a predetermined proximity to the display device) when the display device receives the response message from the electronic device.

FIG. 5B also relates to operation 110 of FIG. 4, which shows a change in presence may be determined when an electronic device is within a predetermined proximity of a display device, and is an alternative to the method of determining the change in presence as illustrated in FIG. 5A and described above. In operation 114 of FIG. 5B, an exchange of data can occur between the electronic device and a server that is communicatively coupled to the electronic device via a communications network. The data exchange may provide the server with at least the location information of the electronic device to the server. At operation 116, the display device can receive updated presence information regarding any devices within its predetermined proximity from the server. That is, the server may use at least the location information provided from the electronic device to transmit updated presence information to the display device which notifies the display device when the electronic device is within its proximity.

In embodiments of the presently disclosed subject matter, according to the location of the electronic device, and the data stored thereon (e.g., contact information, social media interaction data, and the like), the server may determine that the electronic device is within a proximity to a display device that is associated with one of the contacts listed in the electronic device or with the social media interaction data. The server can send a request message to the electronic device to receive an input as to whether the electronic device will accept or decline the sharing of media content data with the display device in the predetermined proximity.

In embodiments of the presently disclosed subject matter, the server can, upon receiving the location of the electronic device, and the data stored thereon (e.g., contact information, social media interaction data, and the like), transmit a message to the display device that is within the proximity of the electronic device and is associated with one of the contacts listed in the electronic device or with the social media interaction data. Upon receipt of the message, the display device can transmit a message to the electronic device to receive an input as to whether the electronic device will accept or decline the sharing of media content data with the display device in the predetermined proximity.

In embodiments of the presently disclosed subject matter, determining the change in presence in operation 110 can include determining a change in presence according to a near filed communication (NFC) between the electronic device and the display device. That is, a user can touch the electronic device to the display device or bring the electronic device within the predetermined proximity to initiate a near field communication between the electronic device and the display device. Via a data exchange using the near field communication, the display device can determine that the electronic device is within the presence of the display device.

In embodiments of the presently disclosed subject matter, determining the change in presence in operation 110 can include determining a change in presence according to at least one of a Wi-Fi communication, a Bluetooth communication, and a short-range wireless communication protocol communication between the electronic device and the display device. That is, a user can touch the electronic device to the display device or bring the electronic device within the predetermined proximity to initiate the at least one of the Wi-Fi communication, the Bluetooth communication, and the short-range wireless communication protocol communication between the electronic device and the display device. According to the data exchange with the at least one of the Wi-Fi communication, the Bluetooth communication, and the short-range wireless communication protocol communication, the display device can determine that the electronic device is within the presence of the display device.

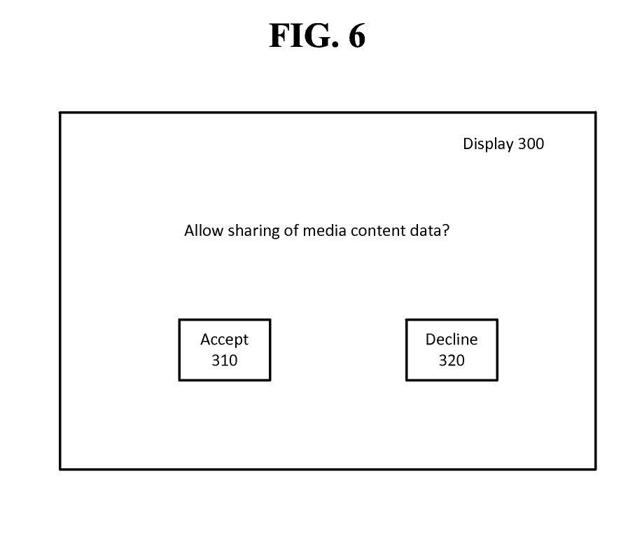

Referring again to FIG. 4, in operation 120, a notification may be transmitted to the electronic device that is within the predetermined proximity of the display device. The notification may request input from the electronic device as to whether to accept or decline sharing media content data with the display device. For example, the notification may be displayed on a display of the electronic device. FIG. 6 shows an example display screen 300 that is displayed on an electronic device to receive an input as to whether to share media content data with a display device according to an embodiment of the disclosed subject matter. When the electronic device receives an input to accept the request to share media content (e.g., the accept 310 of display 300 is selected), permission to share media content data with the display device may be granted. However, when the electronic device receives an input to deny the request to share media content (e.g., the decline 320 of display 300 is selected), permission to share media content data with the display device may be denied and/or declined.

When the accept 310 item of the display 300 is selected in FIG. 6, operation 130 in FIG. 4 may be performed, where media content data can be transmitted from at least one of the electronic device to the display device. When permission is granted by the electronic device to the display device to share media content data, the display device may also receive media content data from a server that can be communicatively coupled to the display device via a communications network and that may have account information associated with, for example, the user of the electronic device.

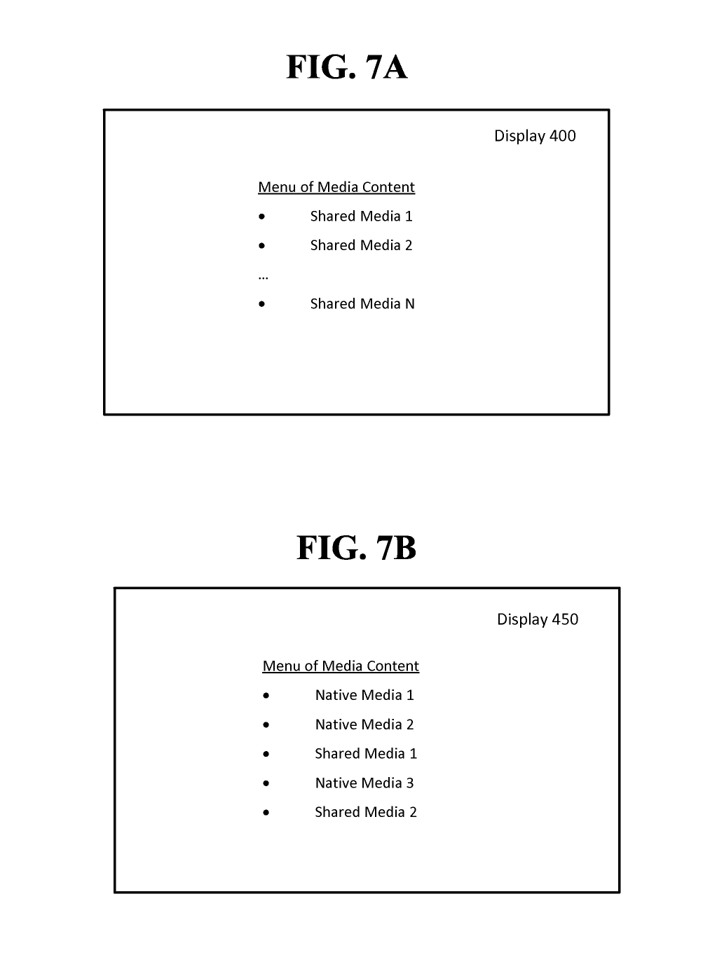

When the electronic device shares media content data with the display device, a menu may be generated and displayed by the display device according to the shared media content data. FIGS. 7A-7B show example display screens that are displayed on the display device to receive a selection of a shared media content item or a native media content item according to an embodiment of the disclosed subject matter. For example, FIG. 7A shows an example display 400 that can be displayed on the display device that includes a menu of media content that is shared by the electronic device. The electronic device can receive a selection of one or more of the shared media content items (e.g., Shared Media 1, Shared Media 2, . . . , Shared Media N as shown in FIG. 7A), and retrieve the media content associated with the selection from the electronic device itself, or from a server that the display device can connect to via a communications network, where the server is identified according to the media content data provided form the electronic device to the display device. The display 400 may present one or more items of the media content items that may be sharable from the electronic device to the display device.

FIG. 7B shows an example display 450 that can be displayed on the display device that includes a menu of media content that is shared by the electronic device (i.e., shared media content), where the menu also include media content that is stored on the display device (i.e., native media content), or in a storage device or server that is communicatively coupled thereto. The electronic device can receive a selection of one or more of the shared media content items (e.g., Shared Media 1 or Shared Media 2, as shown in FIG. 7B) and retrieve the media content associated with the selection from the electronic device itself, or from a server that the display device can connect to via a communications network, where the server is identified according to the media content data provided form the electronic device to the display device, and/or may also receive a selection of native media content (e.g., Native Media 1, Native Media 2, or Native Media 3 as shown in FIG. 7B), and retrieve the media content associated with the selection from a storage device within and/or communicatively coupled to the display device, or from a server. Although three native media items and two shared media items are illustrated in FIG. 7B, the number of native media items and shared media items is for illustrative purposes only, and the menu may include different number of both native and shared media items.

When a selection of a media item (e.g., a shared media item and/or a native media item as illustrated in FIGS. 7A-7B) is received by the display device, the display device can determine whether an application and/or software is needed to present the selected media content item on the display device. When the display device does not have the application and/or software to present the selected media content item on the display device, the display device can obtain the application and/or software from a server that is communicatively coupled to the display device via a communications network.

In an example where the media content data is a game content, saved game data and/or user profile data can be provided to the display device for gameplay to occur. Game files and/or data may be retrieved from a server communicatively connected to the display device for gameplay to occur on the display device.

In the game example described above, where media content data is provided to the display device from the electronic device and/or a server, the electronic device can operate as a game controller, so that the gameplay presented on the display device using the media content data from the electronic device and/or the server, and the electronic device can control gameplay via a communications link with the display device. That is, the electronic device may execute an application so as operate as a controller of the display device for the game play by receiving one or more inputs from a user of the electronic device.

In an example where the media content data is video content, the media content data of the video content can be provided (e.g., streamed) from the electronic device to the display device when an authorization and/or acceptance has been received (e.g., accept 310 has been selected in display 300 shown in FIG. 6 and described above). In embodiments of the presently disclosed subject matter, the media content data of the video content can be provided via a server that is communicatively coupled to the display device. In this embodiment, the electronic device can provide digital rights management (DRM) keys and/or other data to direct the display device to retrieve the video content from the server (e.g., the data can specify the server and/or the specific video content to retrieve), and to use the DRM keys and/or other data to decrypt and/or authorize the playback of the video content on the display device.

Referring again to FIG. 1, in embodiments of the presently disclosed subject matter wherein the determining the change in presence in operation 110 may include determining when the electronic device is positioned so as to be outside the predetermined proximity of the display device. When the electronic device is, for example, moved outside of the predetermined proximity, the display device can removing the media content data that was transmitted to the display device. That is, media content data that is shared by the electronic device according to a permission to allow the sharing of media content data can be removed. For example, the removing can include moving the media content data that was transmitted to the display device to a protected area of a digital storage device coupled to the display device. The removing may also include deleting the media content data that was transmitted to the display device. That is, the transmitted media content that may be have been stored on a digital storage device coupled to the display may be deleted.

In embodiments of the presently disclosed subject matter, a selection may be made with the electronic device to end the acceptance and/or permission to share the media content data with the display device.

Still referring to FIG. 1, the determining the change in presence in operation 110 may include that when the electronic device is positioned so as to be outside the predetermined proximity of the display device, a request message can be transmitted from the display device to the electronic device to maintain permission to access the media content data. The message may be similar to that shown in display 300 of FIG. 6, where the request message requests input as to whether to allow sharing of media content data, and where selection of accept 310 will allow for will grant permission to the display device to continue to have access to the shared media content data, and a selection decline 320 may deny permission for the display device to continue to access the shared media content. That is, the request message may be displayed on a display screen of the electronic device. The electronic device may receive an input as to whether or not to grant permission to the display device to access the media content data when the electronic device is positioned outside the predetermined proximity. The received input to grant or deny permission to access the media content data may be transmitted from the electronic device to the display device.

For example, the electronic device may provide permission to continue to access the shared media content when the electronic device is outside of the proximity, so that others viewing the shared media content (e.g., that is being provided from a server) with the display device can continue to view the media content. In another example, the electronic device may provide permission for the display device to access the shared media content (e.g., that is being provided from a server) for a predetermined amount of time (e.g., 5 minutes, 10 minutes, 30 minutes, 1 hour, etc.) when the device is moved outside the predetermined proximity from the display device. When the predetermined amount of time has elapsed, the display device's permission to access the shared media content data will end, and, as described above, the shared media content may be removed from the display device. In embodiments of the presently disclosed subject matter, a message may be provided on the display device (e.g., that is transmitted from the server) when the predetermined time has elapsed and/or the electronic device has been moved outside the predetermined proximity, which allows for the user of the display device to purchase the media content that has been shared from an authorized source, so that the user may continue to view the media on the display device.

In another example, when the shared media content data is game data, the display device can retrieve the executable file and/or other related files for gameplay from the server when the electronic device has granted permission to the display device to share the game data. When the electronic device moves outside the predetermined proximity, the gameplay may be stopped, and/or the display device may access the shared media content for a predetermined amount of time (e.g., 5 minutes, 10 minutes, 30 minutes, 1 hour, etc.) when the device is moved outside the predetermined proximity from the display device. Once the permission to access the game data is no longer being provided to the display device, the game item in a menu of the display device may be identified as being present, but not accessible (e.g., the item may be greyed out or the like). The user of the display device may be provided with an option to purchase the game from an authorized source, such as a server. In embodiments of the presently disclosed subject matter, when the permission to access the game data is no longer being provided to the display device, the executable files and/or other game files may be retained by the display device, but the key to access and/or use the files that was provided by the electronic device may be discarded. In embodiments of the presently disclosed subject matter, the executable game files and/or other game data may be deleted from the storage device coupled to the display device after a predetermined period of time (e.g., 24 hours, 1 week, 1 month, etc.).

In another example, when the shared media content data is an application, the display device can retrieve the executable file and/or other related files for the application from the server when the electronic device has granted permission to the display device to share the application and/or application data. When the electronic device moves outside the predetermined proximity, the application may be stopped, and/or the display device may access the shared media content (i.e., the application) for a predetermined amount of time (e.g., 5 minutes, 10 minutes, 30 minutes, 1 hour, etc.) when the device is moved outside the predetermined proximity from the display device. Once the permission to access the application is no longer being provided to the display device, the application item in a menu of the display device may be identified as being present, but not accessible (e.g., the item may be greyed out or the like). The user of the display device may be provided with an option to purchase and/or download the application from an authorized source, such as a server. In embodiments of the presently disclosed subject matter, when the permission to access the application is no longer being provided to the display device, the executable files and/or other files associated with the application may be retained by the display device, but the key to access and/or use the files that was provided by the electronic device may be discarded. In embodiments of the presently disclosed subject matter, the executable application files and/or other application data may be deleted from the storage device coupled to the display device after a predetermined period of time (e.g., 24 hours, 1 week, 1 month, etc.).

In another example, when the shared media content data is audio content, the display device can retrieve the audio content from the server (or the electronic device) when the electronic device has granted permission to the display device to share the application and/or application data. When the electronic device moves outside the predetermined proximity, the playback of audio content may be stopped, and/or the display device may access the shared media content (i.e., the audio content) for a predetermined amount of time (e.g., 5 minutes, 10 minutes, 30 minutes, 1 hour, etc.) when the device is moved outside the predetermined proximity from the display device. Once the permission to access the application is no longer being provided to the display device, the audio content of the display device may be identified as being present, but not accessible (e.g., the item may be greyed out or the like). The user of the display device may be provided with an option to purchase and/or download at least a portion of the audio content (e.g., a song, an album, or purchase an access pass to the audio content) from an authorized source, such as a server. In embodiments of the presently disclosed subject matter, when the permission to access the application is no longer being provided to the display device, the audio content may be retained by the display device, but the key to access and/or use the files that was provided by the electronic device may be discarded. In embodiments of the presently disclosed subject matter, the audio content may be deleted from the storage device coupled to the display device after a predetermined period of time (e.g., 24 hours, 1 week, 1 month, etc.).

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
determining a change in presence when an electronic device is within a predetermined proximity of a display device;
transmitting a notification to the electronic device within the predetermined proximity, the notification requesting input from the electronic device to accept or decline sharing media content data with the display device; and
transmitting the media content data to the display device when the acceptance input is received.

2. The method of claim 1, wherein the determining the change in presence comprises:
exchanging data between the display device and the electronic device so that the display device can identify the electronic device when the electronic device is within the predetermined proximity to the display device.

3. The method of claim 1, wherein the determining the change in presence comprises:
exchanging data between the electronic device and a server, so as to provide at least location information of the electronic device to the server; and
receiving, with the display device, updated presence data from the server for the electronic device according to the data exchanged between the display device and the server so that the display device can identify the electronic device as being within the predetermined proximity to the display device.

4. The method of claim 1, wherein the determining the change in presence comprises:
determining a change in presence according to at least one of a near filed communication (NFC), a Wi-Fi communication, a Bluetooth communication, and a short-range wireless communication protocol communication between the electronic device and the display device.

5. The method of claim 1, wherein the transmitting the notification comprises:
transmitting the notification from at least one of the display device and a server that is communicatively coupled to the electronic device when at least one of the display device and the server determines the change in presence in the electronic device is within a predetermined proximity of the display device.

6. The method of claim 1, further comprising:
displaying, in a menu with the display device, at least a portion of the media content data that is received from the electronic device.

7. The method of claim 6, wherein the displayed menu includes media content that is stored on or accessible from the display device.

8. The method of claim 6, further comprising:
receiving a selection, with the display device, of a media content item of the at least a portion of the media content displayed in the menu; and
obtaining, with the display device, at least one application from a server communicatively coupled to the display device to display the selected media content item.

9. The method of claim 6, further comprising:
receiving a selection, with the display device, of a media content item of the at least a portion of the media content displayed in the menu;
transmitting the selection of the media content item from the display device to the electronic device;
transmitting, from the electronic device, media content corresponding to the selected media content item to the display device; and
presenting at least a portion of the media content received from the electronic device with the display device.

10. The method of claim 6, further comprising:
receiving a selection, with the display device, of a media content item of the at least a portion of the media content displayed in the menu;
retrieving media content corresponding to the selected media content item from a server communicatively coupled to the display device; and
presenting at least a portion of the retrieved media content with the display device.

11. The method of claim 1, wherein the media content data includes at least one of video media content, audio media content, game media content, game data, application content, application data, image media content, subscription data, account data, media purchase data, authorization data, user profile data, electronic device data, and digital right management (DRM) keys to decrypt the selected media content data.

12. The method of claim 1, wherein the determining the change in presence further comprises:
when the electronic device is positioned so as to be outside the predetermined proximity of the display device, removing the media content data that was transmitted to the display device.

13. The method of claim 12, wherein the removing comprises:
moving the media content data that was transmitted to the display device to a protected area of a digital storage device coupled to the display device.

14. The method of claim 12, wherein the removing comprises:
deleting the media content data that was transmitted to the display device.

15. The method of claim 1, wherein the determining the change in presence further comprises:
when the electronic device is positioned so as to be outside the predetermined proximity of the display device, transmitting a request message from the display device to the electronic device to maintain permission to access the media content data;
displaying the request message with the electronic device;
receiving an input with the electronic device as to whether or not to grant permission to the display device to access the media content data when the electronic device is positioned outside the predetermined proximity; and
transmitting, from the electronic device to the display device, the received input to grant or deny permission to access the media content data.

16. A system comprising:
an electronic device to provide media content data;
a display device; and
a server to determine a change in presence when the electronic device is within a predetermined proximity of the display device according to data transmitted from the electronic device to the server, and to transmit media content to the display device according to the media content data provided by the electronic device when an input is received to share the media content data and when a selection of a media content item of the media content data is received.

17. The system of claim 16, wherein the electronic device transmits the media content to the display device when the input is received to share the media content data and when the selection of the media content item of the media content data is received.

18. A system comprising:
an electronic device to provide media content data;
a display device to determine a change in presence when the electronic device is within a predetermined proximity of the display device according to data communication between the display device and the electronic device; and
a server to transmit media content to the display device according to the media content data provided by the electronic device when an input is received to share the media content data and when a selection of a media content item of the media content data is received.

19. The system of claim 18, wherein the electronic device transmits the media content to the display device when the input is received to share the media content data and when the selection of the media content item of the media content data is received.
